(19) United States
(12) Patent Application Publication
(10) Pub. No.: US 2010/0151887 A1
(43) Pub. Date: Jun. 17, 2010

(54) Mobile handset proximity social networking

(75) Inventor: Joseph A. Bobier, Sunrise, FL (US)

Correspondence Address: THE LAW OFFICES OF DENNIS L. COOK, PLLC, 10004 MARATHON COURT, TAMPA, FL, 33615, US

(73) Assignee: xG Technology, Inc., Sarasota, FL (US)

(21) Appl. No.: 12/653,445

(22) Filed: Dec. 14, 2009

Related U.S. Application Data
(60) Provisional application No. 61/201,807, filed on Dec. 15, 2008.

(51) Int. Cl. H04W 24/00; G06F 15/16

(52) U.S. Cl. 455/457; 709/204

(57) ABSTRACT

A system and method which allows for a more direct form of presenting useful information to a mobile handset user is disclosed. More specifically a method to facilitate social networking activated by the relative proximity of one mobile handset user to another that alerts mobile users when friends or co-workers are within a given proximity is disclosed.

### CROSS-REFERENCE TO RELATED APPLICATION

The present application claims the benefit of previously filed co-pending Provisional Patent Application, Ser. No. 61/201,807.

### FIELD OF INVENTION

This invention relates to a system which allows for a more direct form of presenting useful information to a mobile handset user, and more specifically is a method to facilitate social networking activated by the relative proximity of one mobile handset user to another.

### BACKGROUND OF INVENTION

Social networking has long been a goal of business people and sales people to increase market awareness and sales. With the advent of the World Wide Web social networking spread through use of the Internet starting with rudimentary mass e-mailings to the now trendy networking sites such as MySpace and FaceBook where social networking goes well beyond business uses to become a social phenomena. Now, with the next iteration of the Internet, the mobile Web, spreading around the world, the next generation cell phones and personal data assistants (PDAs) are opening up social networking possibilities never before imagined. An invention is disclosed that adds a new social networking function to mobile handsets. Furthermore, the social networking function is activated by a relative proximity of one user to another.

The following disclosure will describe a method of making such social networking available to all mobile handset users within a certain proximity range simultaneously.

### BRIEF SUMMARY OF THE INVENTION

An invention is disclosed that adds a new social networking function to mobile handsets. Furthermore, the social networking function is activated by a relative proximity of one user to another.

It is therefore an object of the invention to supply increased functionality to a mobile handset allowing real time social networking to become available to all mobile handset users within a certain proximity range simultaneously, and, as a further object of the invention, to alert mobile users when friends or co-workers are within a given proximity.

### DESCRIPTION OF PREFERRED EMBODIMENT

For purposes of the preferred embodiment, suppose a mobile user is within some distance of another compatible user, perhaps in the order of a mile or two. The application software running in the mobile device will notify the similarly equipped user of his relative presence by an audible and/or vibration alert. The signaled user can view his device and see the name or nickname of the other user in a list of potentially other users. A user can have the option to disable the announcement of his presence. Essentially this is a mobile buddy list that is driven by the near proximity of other users. Users may then text other users within the proximity area. Text messages may then be privately sent, or sent via a chat room type application. A quick option is also provided to phone the other user by selecting the user in the list and then pressing “dial”.

There are three ways to detect the relative proximity of one user to another. The first method is to detect other users that are within direct radio contact of each other. In this embodiment each handset will periodically transmit an announcement beacon, which is not processed by the base station network. Other mobile handsets that hear the announcement beacon will register the user in the social networking application program. Once registration occurs, notification will occur.

The second method is by use of a GPS receiver within each handset to routinely note the present location. Signaling to other users then takes place through the base station network. In this embodiment the mobile device transmits its location information to the base station network on a periodic basis, then that announcement is re-broadcast to other local handsets and notification and registration will happen if the other users are within a prescribed relative proximity.

The third method makes use of other handset location methods such as triangulation, which is commonly done to locate handsets that are not equipped with GPS. It is essentially done the same way as method two, with somewhat less precision.

Since certain changes may be made in the above described mobile handset proximity social networking system and method without departing from the scope of the invention herein involved, it is intended that all matter contained in the description thereof, or shown in any accompanying figures shall be interpreted as illustrative and not in a limiting sense.

What is claimed is:

1. A method for social networking between mobile phone or personal digital assistant users within a set proximity without using a base station comprising:
two or more users using a mobile phone or personal digital assistant having a social networking application software that stores information regarding friends and is capable of notifying a user of friends information;
said mobile phone or personal digital assistant transmitting beacons not processed by a base station with information regarding the identity of a user;
said mobile phone or personal digital assistant being capable of receiving said beacons when one user is within a set proximity of another user; and,
wherein when said one user's said mobile phone or personal digital assistant receives said beacons of said another user's mobile phone or personal digital assistant within a set proximity said one user's mobile phone or personal digital assistant uses said social networking application software program to parse out the identity of said another user from said beacons and to notify said one user of the identity of said another user thus letting said one user know said another user is within a set proximity and said social networking application software program displays information regarding said another user to said one user through said mobile phone or personal digital assistant's display screen.

2. A method for social networking between mobile phone or personal digital assistant users within a set proximity by using a base station comprising:
two or more users using a mobile phone or personal digital assistant having global positioning satellite location capability and a social networking application software that stores information regarding friends and is capable of notifying a user of friends information;
said mobile phone or personal digital assistant transmitting to a base station information regarding the identity of a user and location information;
said base station transmitting the identity and location information of a user to said mobile phone or personal digital assistant of two or more users within a set proximity;
said mobile phone or personal digital assistant being capable of using said social networking application software to recognize when one user is within a set proximity of another user; and,
wherein when said one user's said mobile phone or personal digital assistant recognizes that one user is within a set proximity of another user said one user's mobile phone or personal digital assistant uses said social networking application software program to notify said one user of the identity of said another user and said social networking application software program displays information regarding said another user to said one user through said mobile phone or personal digital assistant's display screen.

3. The method for social networking between mobile phone or personal digital assistant users within a set proximity by using a base station of claim 2 wherein triangulation is used to determine location information.
